(19) United States
(12) Patent Application Publication
(10) Pub. No.: US 2024/0224372 A1
(43) Pub. Date: Jul. 4, 2024

(54) METHOD FOR PRECONFIGURED RESOURCE-BASED SMALL DATA TRANSMISSION AND TERMINAL DEVICE

(71) Applicant: GUANGDONG OPPO MOBILE TELECOMMUNICATIONS CORP., LTD., Dongguan (CN)

(72) Inventors: Xue LIN, Dongguan (CN); Shukun WANG, Dongguan (CN); Xin YOU, Dongguan (CN); Zhe FU, Dongguan (CN)

(21) Appl. No.: 18/585,028

(22) Filed: Feb. 22, 2024

Related U.S. Application Data
(63) Continuation of application No. PCT/CN2021/125758, filed on Oct. 22, 2021.

(51) Int. Cl. H04W 76/27; H04L 1/08

(52) U.S. Cl. CPC H04W 76/27; H04L 1/08

(57) ABSTRACT

The present disclosure provides a method for preconfigured resource-based small data transmission (SDT) and a terminal device. The method includes the following. A terminal device transmits a first message during operation of a first timer after selecting a configured grant (CG)-SDT, where the first message includes a 1st uplink message sent during the SDT, and the 1st uplink message at least includes a radio resource control (RRC) message.

### CROSS REFERENCE TO RELATED APPLICATION(S)

This application is a continuation of International Application No. PCT/CN2021/125758, filed Oct. 22, 2021, the entire disclosure of which is incorporated herein by reference.

### TECHNICAL FIELD

The present disclosure relates to the field of wireless communication, and more particularly, to a method for preconfigured resource-based small data transmission (SDT) and a terminal device.

### BACKGROUND

Small data transmission (SDT) allows a terminal device in a radio resource control (RRC) inactive state to perform data transmission.

In the related art, during configured grant (CG) SDT, when the transmission of a first message is completed in an initial transmission phase, data transmission may be performed in a subsequent transmission phase.

However, how to ensure the successful transmission of the first message is a problem to be solved.

### SUMMARY

In a first aspect, a method for preconfigured resource-based small data transmission (SDT) is provided. The method includes the following. A terminal device transmits a first message during operation of a first timer after selecting a configured grant (CG)-SDT, where the first message includes a 1st uplink message sent during the SDT, and the 1st uplink message at least includes a radio resource control (RRC) message.

In a second aspect, a method for preconfigured resource-based SDT is provided. The method includes the following. A network device configures a duration of a first timer for a terminal device, so that the terminal device transmits a first message during operation of the first timer. The network device receives the first message, where the first message includes a 1st uplink message sent during the SDT, and the 1st uplink message at least includes an RRC message.

In a third aspect, a terminal device is provided. The terminal device includes: a transceiver, a memory configured to store computer programs, and a processor configured to execute the computer programs stored in the memory to cause the transceiver to: transmit a first message during operation of a first timer after selecting a CG-SDT, where the first message includes a 1st uplink message sent during the SDT, and the 1st uplink message at least includes an RRC message.

### BRIEF DESCRIPTION OF THE DRAWINGS

In order to describe technical solutions in embodiments of the disclosure more clearly, the following will give a brief introduction to the accompanying drawings required for describing embodiments. Apparently, the accompanying drawings hereinafter described are merely some embodiments of the disclosure. Based on these drawings, those of ordinary skill in the art can also obtain other drawings without creative effort.

FIG. 1 is a flowchart of a data transmission procedure of early data transmission (EDT).

FIG. 2 is a flowchart of data transmission with a preconfigured uplink resource (PUR).

FIG. 3 is a diagram of a time-frequency resource of the transmission process of configured grant (CG)-small data transmission (SDT).

FIG. 4 is a block diagram of a communication system provided in an exemplary embodiment of the disclosure.

FIG. 5 is a flowchart of a method for preconfigured resource-based SDT provided in an embodiment of the disclosure.

FIG. 6 is a flowchart of a method for preconfigured resource-based SDT provided in an embodiment of the disclosure.

FIG. 7 is a flowchart of a method for preconfigured resource-based SDT provided in an embodiment of the disclosure.

FIG. 8 is a diagram of a time-frequency resource of the transmission process of CG-SDT provided in an embodiment of the disclosure.

FIG. 9 is a flowchart of a method for preconfigured resource-based SDT provided in an embodiment of the disclosure.

FIG. 10 is a diagram of a time-frequency resource of the transmission process of CG-SDT provided in an embodiment of the disclosure.

FIG. 11 is a flowchart of a method for preconfigured resource-based SDT provided in an embodiment of the disclosure.

FIG. 12 is a diagram of a time-frequency resource of the transmission process of CG-SDT provided in an embodiment of the disclosure.

FIG. 13 is a flowchart of a method for preconfigured resource-based SDT provided in an embodiment of the disclosure.

FIG. 14 is a diagram of a time-frequency resource of the transmission process of CG-SDT provided in an embodiment of the disclosure.

FIG. 15 is a flowchart of a method for preconfigured resource-based SDT provided in an embodiment of the disclosure.

FIG. 16 is a flowchart of a method for preconfigured resource-based SDT provided in an embodiment of the disclosure.

FIG. 17 is a diagram of a time-frequency resource of the transmission process of CG-SDT provided in an embodiment of the disclosure.

FIG. 18 is a flowchart of a method for preconfigured resource-based SDT provided in an embodiment of the disclosure.

FIG. 19 is a flowchart of a method for preconfigured resource-based SDT provided in an embodiment of the disclosure.

FIG. 20 is a flowchart of a method for preconfigured resource-based SDT provided in an embodiment of the disclosure.

FIG. 21 is a flowchart of a method for preconfigured resource-based SDT provided in an embodiment of the disclosure.

FIG. 22 is a flowchart of a method for preconfigured resource-based SDT provided in an embodiment of the disclosure.

FIG. 23 is a block diagram of a device for preconfigured resource-based SDT provided in an embodiment of the disclosure.

FIG. 24 is a block diagram of a device for preconfigured resource-based SDT provided in an embodiment of the disclosure.

FIG. 25 is a schematic structural diagram of a communication apparatus provided in an embodiment of the disclosure.

### DETAILED DESCRIPTION

In order to make purposes, technical solutions, and advantages of the disclosure clearer, the following will further describe in detail embodiments of the disclosure with reference to the accompanying drawings.

Example embodiments are described in detail herein, and examples of the example embodiments are presented in the accompanying drawings. When the following description relates to the accompanying drawings, same numbers in different accompanying drawings represent a same or similar element unless otherwise stated. Implementations described in the following example embodiments do not represent all implementations consistent with the present disclosure. On the contrary, they are only examples of apparatus and methods that are described in the appended claims in detail and that are consistent with some aspects of the present disclosure.

Network architectures and service scenarios described in the embodiments of the disclosure are intended to more clearly describe the technical solutions in the embodiments of the disclosure, and do not constitute any limitation on the technical solutions provided in the embodiments of this disclosure. Those of ordinary skill in the art may learn that the technical solutions provided in the embodiments of this disclosure are also applicable to a similar technical problem as a network architecture evolves and a new service scenario emerges.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items.

It is to be understood that, although terms of “first”, “second”, and the like are used for description of various information in the present disclosure, information are not limited to these terms. These terms are only used for distinguishing information with the same type. For example, without departing from the scope of the present disclosure, the first information may also be referred to as the second information; similarly, the second information may also be referred to as the first information. Depending on the context, such as the words in the use of “if” can be interpreted as “when . . . ” or “during . . . ” or “in response to determining”.

Firstly, a brief introduction will be given to the terms involved in embodiments of the disclosure.

### Early Data Transmission (EDT)

In long term evolution (LTE), EDT (also known as small data transmission) has been introduced. During the EDT, a terminal device may complete transmission of uplink and/or downlink small data packets while always remaining in an idle state (RRC_IDLE), a suspend state (RRC_SUSPEND), or an inactive state (RRC_INACTIVE). In terms of configuration, a network device will configure in a system information block 2 (SIB2) a maximum transport block (TB) size that the current network allows for transmission, and the terminal device can determine the amount of data to be transmitted. If the amount of data to be transmitted is smaller than the maximum TB size as broadcasted, the terminal device can initiate an EDT transmission. Otherwise, the terminal device enters a connected state to transmit the data via a normal connection establishment process.

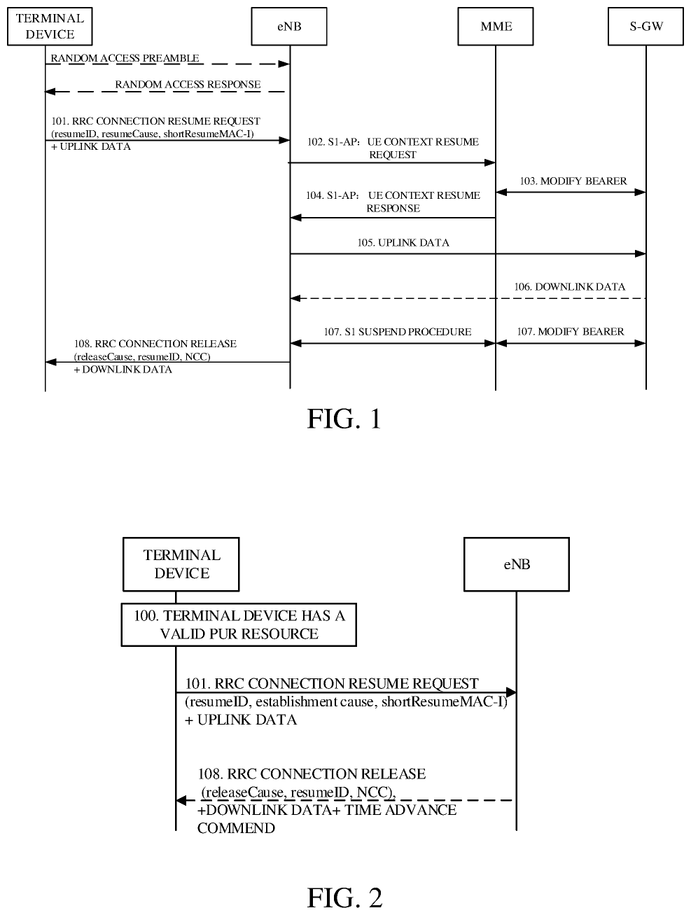

If the cell in which the terminal device initiates the uplink EDT is the same as the final serving cell, after receiving an RRC connection resume request and uplink data sent by the terminal device, a base station can directly submit the uplink data to a core network, the specific process of which is as illustrated in FIG. 1.

### Preconfigured Uplink Resource (PUR)

In long term evolution (LTE) release 16 (R16), for narrow band-internet of things (NB-IoT) and enhanced machine type communication (eMTC) scenarios, a data transmission method using PUR in the idle state is introduced. The PUR is only valid in the currently configured cell. That is, when a user equipment (UE) detects a cell change and initiates random access in a new cell, the UE needs to release the PUR configured in the previous cell. The PUR transmission process is similar to the LTE UP-EDT, except that the process of transmitting a preamble to obtain a timing advance (TA) and an uplink (UL) grant is omitted, the specific process of which is as illustrated in FIG. 2.

### Small Data Transmission (SDT)

In a 5G NR system, RRC states are divided into three types, namely, an RRC idle state (RRC_IDLE), an RRC inactive state (RRC_INACTIVE), and an RRC connected state (RRC_CONNECTED).

The RRC_INACTIVE state is a new state introduced in the 5G system from a perspective of energy saving. For a terminal device in the RRC_INACTIVE state, a radio bearer (RB) and all radio resources will be released, but a UE access context is maintained at the terminal device side and the base station side so as to quickly resume an RRC connection. The network usually keeps a terminal device with infrequent data transmission in the RRC_INACTIVE state.

Before R16, a terminal device in the RRC_INACTIVE state does not support data transmission. When uplink or downlink data arrives, the terminal device needs to resume the connection, and is then released to the RRC_INACTIVE state after the data transmission is completed. For a terminal device with small data amount and low transmission frequency, such a transmission mechanism will lead to unnecessary power consumption and signaling overhead. Therefore, in release 17 (R17), a project for research on SDT under RRC_INACTIVE is initiated, with two major target directions: SDT based on random access (two-step/four-step) and preconfigured resource-based SDT, for example, configured grant (CG) type 1 SDT.

For the preconfigured resource-based SDT, the 3GPP RAN2 working group has come to an agreement as follow after discussion.

1. Support retransmission by dynamic grant for CG-SDT.

2. Support multiple hybrid automatic repeat request (HARQ) processes for uplink CG-SDT.

3. For CG-SDT, the subsequent data transmission can use the CG resource or dynamic grant (DG) (i.e. dynamic grant addressed to UE's cell-radio network temporary identifier (C-RNTI)). Details on C-RNTI, can be the same as the previous C-RNTI or may be configured explicitly by the network can be discussed in stage 3.

4. During subsequent CG transmission phase (i.e. after the UE has received response from NW) UE can initiate at least legacy random access channel (RACH) procedure (e.g. trigger due to no UL resources). No media access control (MAC) packet data unit (PDU) rebuilding is required. FFS if the RA-SDT RA resources can be used for subsequent data.

a. At least the following conditions are agreed: (1) no qualified synchronization signaling block (SSB) when the evaluation is performed; (2) when timing advance (TA) is invalid; (3) when selective repeat (SR) is triggered due to lack of UL resource.

5. The C-RNTI previously configured in RRC_CONNECTED state is used for UE to monitor physical downlink control channel (PDCCH) in CG-SDT.

6. Configured scheduling-radio network temporary identifier (CS-RNTI) based dynamic retransmission mechanism can be reused for CG-SDT. FFS whether CS-RNTI is the same one as the one previously configured in RRC_CONNECTED or a new CS-RNTI one is provided to the UE.

7. During the subsequent new CG transmission phase, for the purpose of CG resource selection, UE re-evaluates the SSB for subsequent CG transmission. FFS what happens if no SSBs are valid or if no sample is available.

According to the agreement, during CG-SDT, a UE may perform new transmission of data on a CG resource or a DG resource, and retransmission is based on a dynamic scheduling by the network. Each time the UE uses a CG resource for new transmission of data, the UE needs to re-evaluate the SSB configured with the CG resource i.e., to determine whether there is an SSB that meets a reference signal received power (RSRP) threshold and is configured with a CG resource.

In the subsequent transmission phase of the CG-SDT, the UE initiates a conventional RACH procedure if at least one of the following conditions is met.

1. There is no SSB that meets the RSRP threshold and is configured with a CG resource when the SSB re-evaluation is performed.

2. TA is invalid, including that a time alignment timer (TAT) expires and/or the amount of change of an RSRP exceeds a threshold.

3. There is no uplink resource for transmission of SR.

It is to be noted that the subsequent transmission means that a during the SDT, after successfully completing the first transmission of uplink data, the UE continues to perform the transmission of the uplink data without changing the terminal state, i.e., remaining in the RRC_CONNECTED state.

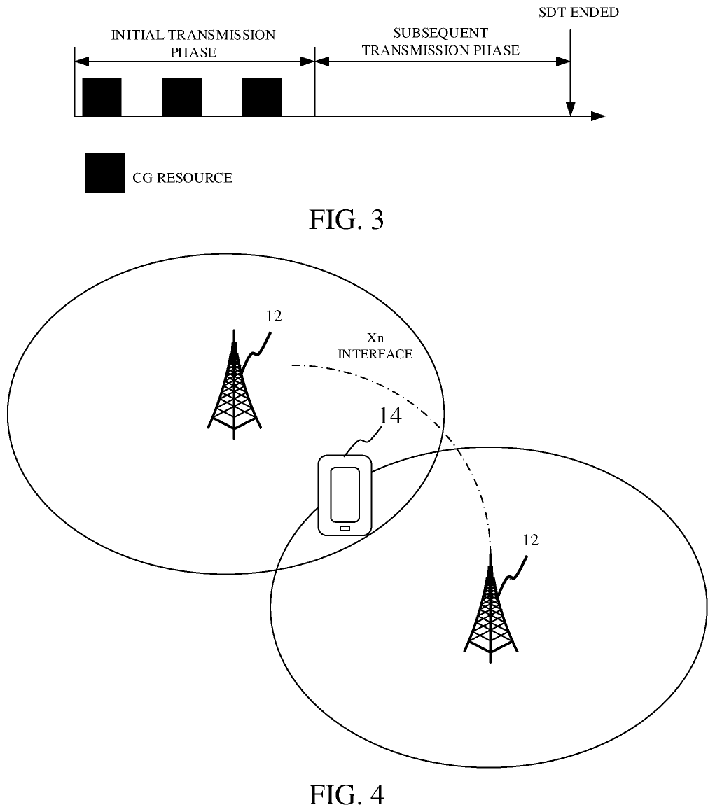

According to the 3GPP meeting, the transmission process of the CG-SDT can be divided into two phases, namely, an initial transmission phase and a subsequent transmission phase. FIG. 3 is a diagram of a time-frequency resource of the transmission process of CG-SDT.

FIG. 4 is a block diagram of a communication system provided in an exemplary embodiment of the disclosure. The communication system may include a network device 12 and a terminal device 14.

The network device 12 maybe a base station, which is a device deployed in the access network to provide a wireless communication function for terminals. The base station may include various forms of macro base stations, micro base stations, relay stations, access points, and the like. In systems using different radio access technologies, the names of devices with the function of base station may be different. For example, in the LTE system, it may be called as eNodeB or eNB, and in the 5G NR-U system, it may be called as gNodeB or gNB. As the communication technology evolves, the description of “base station” maychange. For the convenience of describing embodiments of the disclosure, the above-mentioned device used for providing the wireless communication function for the terminal device 14 maybe collectively referred to as a network device. Optionally, an interface between network devices 12 is a Xn interface.

The terminal device 14 mayinclude various handheld devices, vehicle-mounted devices, wearable devices, computing devices with wireless communication functions, or other processing devices connected to wireless modems, as well as various forms of UE, mobile stations (MS), terminal devices, and the like. For the convenience of description, the devices mentioned above may be collectively referred to as a terminal device. The network device 12 and the terminal device 14 communicate with each other through a certain air interface technology, such as a Uu interface. Optionally, the terminal device 14 supports performing the SDT in the RRC_INACTIVE state.

The technical solutions according to some embodiments of the disclosure may be applied to various communication systems, such as global system of mobile communication (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD) system, advanced long term evolution (LTE-A) system, new radio (NR) system, evolution system of the NR system, LTE-based access to unlicensed spectrum (LTE-U) system, NR-U system, universal mobile telecommunication System (UMTS), worldwide interoperability for microwave access (WiMAX) communication system, wireless local area networks (WLAN), wireless fidelity (WiFi), next-generation communication systems or other communication systems.

Generally speaking, traditional communication systems support a limited number of connections and are easy to be implemented. However, with the development of communication technology, mobile communication systems will not only support traditional communication, but also support, for example, device to device (D2D) communication, machine to machine (M2M) communication, machine type communication (MTC), vehicle to vehicle (V2V) communication, vehicle to everything (V2X) system, and the like. Embodiments of the disclosure may also be applied to these communication systems.

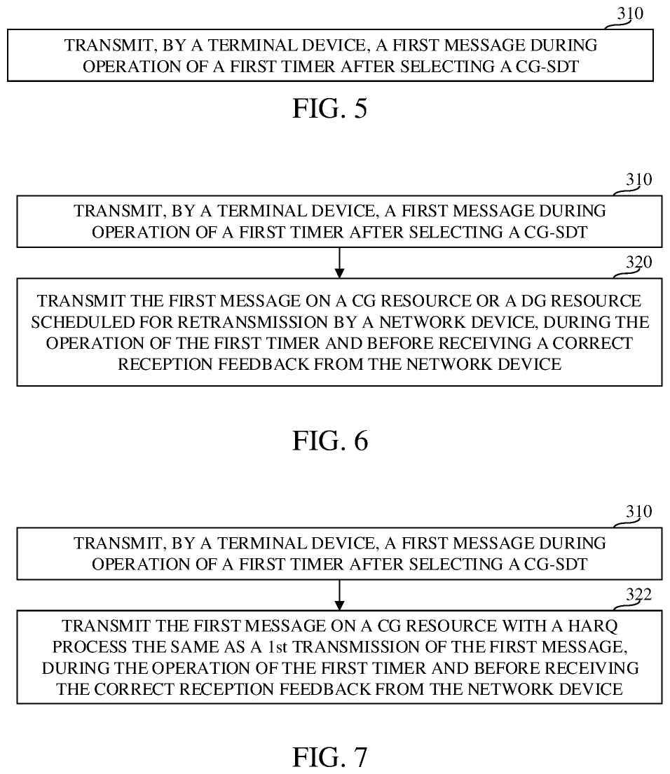

FIG. 5 is a flowchart of a method for preconfigured resource-based SDT provided in an embodiment of the disclosure. The method may be implemented by the terminal device illustrated in FIG. 4, and the method includes the following.

At 310, a terminal device transmits a first message during operation of a first timer after selecting a CG-SDT.

Exemplarily, the terminal device is in an RRC_INACTIVE state when selecting the CG-SDT. The terminal device triggers the CG-SDT when a target condition is satisfied. Exemplarily, the target condition includes but is not limited to any one of the following.

Data to-be transmitted all belongs to an RB that is allowed to trigger SDT, and the amount of the data to-be-transmitted is not greater than a data amount threshold configured by a network.

A measurement result of an RSRP is not less than an RSRP threshold configured by the network.

A CG resource exists in a selected carrier and a SSB.

TA is valid, i.e., a TAT is in operation and/or the amount of change of the RSRP does not exceed a threshold.

The first message includes a 1st uplink message sent in the SDT, and the 1st uplink message at least includes a radio resource control (RRC) message. Exemplarily, the RRC message is an RRC resume request message.

Optionally, the first message also includes terminal data. Exemplarily, the terminal data is user plane data and/or control plane data.

Optionally, the first message also includes a medium access control control element (MAC CE). Exemplarily, the MAC CE is a buffer status report (BSR) MAC CE.

Exemplarily, the terminal device starts the first timer after selecting the CG-SDT. A duration of the first timer is configured by a network device. Exemplarily, the first timer is used to control the SDT. Optionally, the first timer is a timer maintained at an RRC layer.

Exemplarily, the terminal device performs the 1st transmission of the first message during the operation of the first timer.

Optionally, the terminal device skips transmitting a second message during the operation of the first timer and without receiving a correct reception feedback from the network device, where the second message is a message to be transmitted in a subsequent transmission phase of the SDT. Exemplarily, the second message is different from the first message. Exemplarily, the subsequent transmission phase is a subsequent transmission phase in the diagram of time-frequency resource of the transmission process of CG-SDT illustrated in FIG. 3.

In conclusion, according to the method provided in the embodiment, the first timer is added and the first message is transmitted during the operation of the first timer, thereby improving the mechanism for transmitting the first message during the preconfigured resource-based SDT, ensuring that the first message can be transmitted in an initial transmission phase, and providing a solution for transmitting the first message.

FIG. 6 is a flowchart of a method for preconfigured resource-based SDT provided in an embodiment of the disclosure. The method may be implemented by the terminal device illustrated in FIG. 4, and the method includes the following.

At 310, a terminal device transmits a first message during operation of a first timer after selecting a CG-SDT.

This operation may refer to operation 310 in the embodiment illustrated in FIG. 5, which will not be elaborated again herein.

At 320, the terminal device transmits the first message on a CG resource or a DG resource scheduled for retransmission by a network device, during the operation of the first timer and before receiving a correct reception feedback from the network device.

The correct reception feedback indicates that the first message is received and successfully decoded. Exemplarily, the correct reception feedback is a hybrid automatic repeat request-acknowledgment (HARQ-ACK).

The DG resource is a dynamic resource scheduled by the network device. Exemplarily, the network device schedules the DG resource for transmitting the first message when the first message is received but not successfully decoded. The DG resource is usually different from the CG resource, but possibilities exist that the DG resource is the same as the CG resource. Exemplarily, HARQ processes on the same resource have the same identity (ID), and HARQ processes on different resources have different IDs.

In the embodiment, the first message may be transmitted on the CG resource, or may be transmitted on the DG resource scheduled for retransmission by the network device. Those of ordinary skill in the art may understand that the preconfigured resource-based SDT may be completed by using any one of the foregoing two methods. The foregoing two methods may be divided into two different embodiments.

Exemplarily, the terminal device maintains the CG-SDT and does not fall back to a random access (RA)-SDT or an RACH procedure during the operation of the first timer and before receiving the correct reception feedback from the network device.

In conclusion, according to the method provided in the embodiment, the first message is transmitted during the operation of the first timer, thereby improving the mechanism for transmitting the first message during the preconfigured resource-based SDT. In addition, a method of transmitting the first message on the CG resource or the DG resource scheduled for retransmission by the network device without receiving the correct reception feedback from the network device is provided, thereby further ensuring that the first message can be successfully transmitted in an initial transmission phase.

As for continuously transmitting the first message on a CG resource, there are two implementations in the disclosure.

In implementation 1, the first message is transmitted on CG resources for the same HARQ process. FIG. 7 is a flowchart of a method for preconfigured resource-based SDT based on implementation 1.

In implementation 2, the first message is transmitted on CG resources for the same HARQ process or different HARQ processes. FIG. 9 is a flowchart of a method for preconfigured resource-based SDT based on implementation 2.

The two implementations are described in detailed below.

### Implementation 1

At 322, the first message is transmitted on a CG resource with a HARQ process the same as a 1st transmission of the first message, during the operation of the first timer and before receiving the correct reception feedback from the network device.

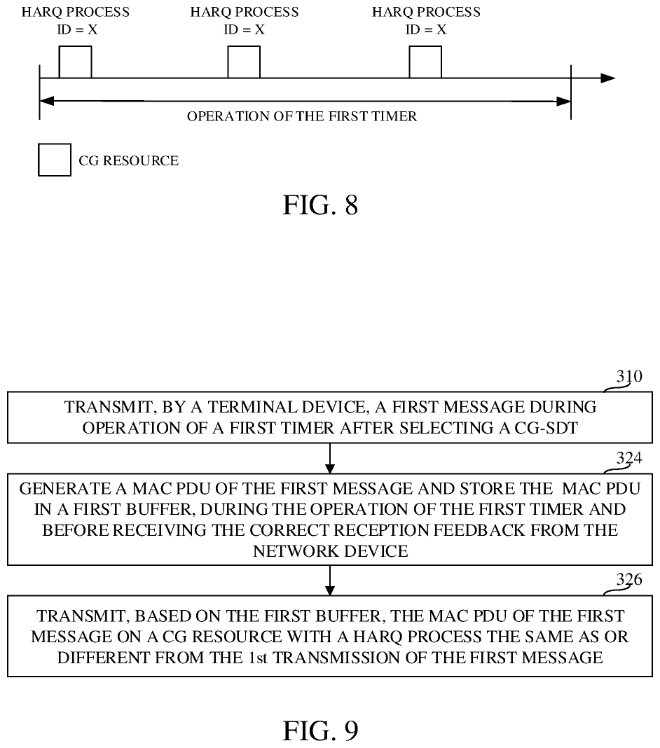

Exemplarily, the same HARQ process has the same ID. For example, the CG resource used for continuously transmitting the first message corresponds to a HARQ process ID X. FIG. 8 is a diagram of a time-frequency resource of the transmission process of CG-SDT provided in an embodiment of the disclosure. Three CG resources are illustrated in the diagram of the time-frequency resource and have the same HARQ process ID. That is, the terminal device transmits the first message on a CG resource with a HARQ process the same as the 1st transmission of the first message. The three CG resources illustrated in FIG. 8 each correspond to the HARQ process ID X.

### Implementation 2

At 324, a MAC PDU of the first message is generated and the MAC PDU is stored in a first buffer, during the operation of the first timer and before receiving the correct reception feedback from the network device.

Exemplarily, the MAC PDU is generated during the 1st transmission of the first message after the terminal device selects the CG-SDT. The MAC PDU is stored in the first buffer by the terminal device.

At 326, based on the first buffer, the MAC PDU of the first message is transmitted on a CG resource with a HARQ process the same as or different from the 1st transmission of the first message.

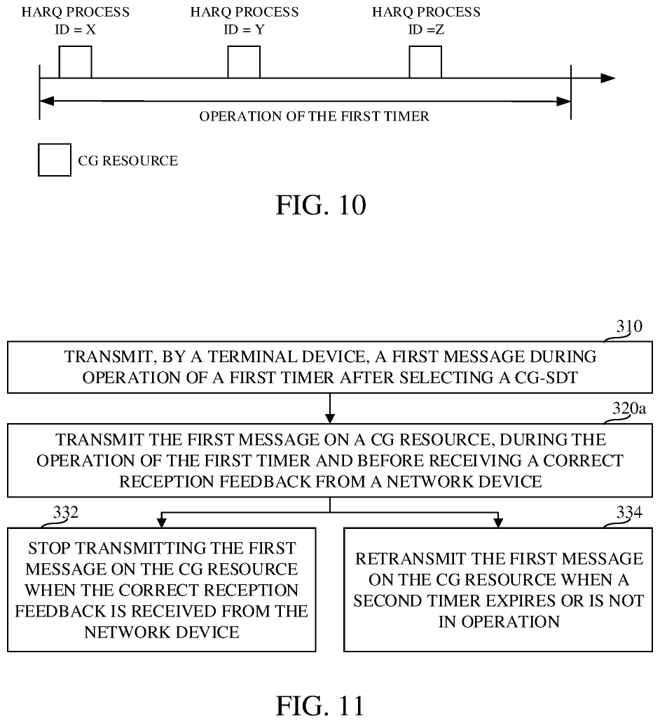

CG resources used for transmitting the MAC PDU of the first message may have the same HARQ process ID or different HARQ process IDs. For example, the CG resource used for the 1st transmission of the first message corresponds to a HARQ process ID X, and the CG resource used for the 2nd transmission of the first message corresponds to a HARQ process ID Y. Alternatively, CG resources used for the transmission of the first message each correspond to the HARQ process ID X. FIG. 10 is a diagram of a time-frequency resource of the transmission process of CG-SDT provided in an embodiment of the disclosure. Three CG resources are illustrated in the diagram of the time-frequency resource and have different HARQ process IDs. The three CG resources illustrated in FIG. 10 correspond to HARQ process ID X, Y, and Z respectively.

Optionally, the terminal device stores the MAC PDU stored in the first buffer into a buffer corresponding to any HARQ process when the terminal device newly transmits the first message on a CG resource of the any HARQ process.

The terminal device stores the MAC PDU in the first buffer into a buffer corresponding to any HARQ process when the terminal device newly transmits the first message on a CG resource of the any HARQ process.

In conclusion, according to the method provided in the embodiment, two implementations of transmitting the first message are provided, which further enriches the mechanism for transmitting the first message during the preconfigured resource-based SDT. In this way, the first message may be transmitted in different situations, thereby further ensuring the successful transmission of the first message in an initial transmission phase.

As for continuously transmitting the first message on a CG resource, FIG. 11 is a flowchart of a method for preconfigured resource-based SDT provided in an embodiment of the disclosure. The method may be implemented by the terminal device illustrated in FIG. 4, and the method includes the following.

At 310, a terminal device transmits a first message during operation of a first timer after selecting a CG-SDT.

This operation may refer to operation 310 in the embodiment illustrated in FIG. 5, which will not be elaborated again herein.

At 320a, the terminal device transmits the first message on a CG resource, during the operation of the first timer and before receiving a correct reception feedback from a network device.

This operation may refer to operation 320 in the embodiment illustrated in FIG. 6, which will not be elaborated again herein.

Embodiments of the disclosure also include any one of the following operations.

At 332, the terminal device stops transmitting the first message on the CG resource when the correct reception feedback is received from the network device. The correct reception feedback indicates that the first message is received and successfully decoded. Exemplarily, the correct reception feedback is a HARQ-ACK.

At 334, the terminal device retransmits the first message on the CG resource when a second timer expires or is not in operation.

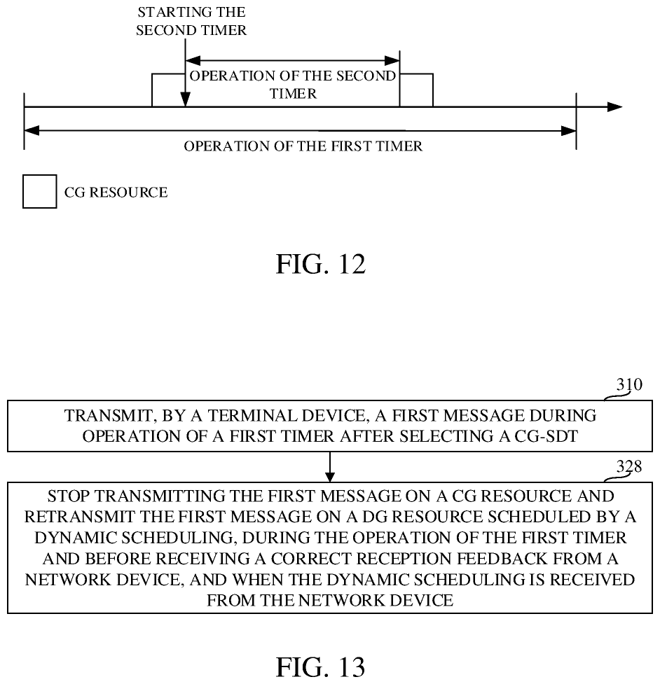

Exemplarily, the terminal device starts the second timer when completing the transmission of the first message on a CG resource. A duration of the second timer is configured by the network device. Exemplarily, the second timer is a configured grant retransmission timer (CGRT). FIG. 12 is a diagram of a time-frequency resource of the transmission process of CG-SDT provided in an embodiment of the disclosure. Two CG resources are illustrated in the diagram of the time-frequency resource. The second timer is started after the terminal device completes the transmission of the first message on the 1st CG resource. The terminal device transmits the first message on the 2nd CG resource when the second timer expires. The 1st CG resource and the 2nd CG resource may correspond to the same HARQ process, or may correspond to different HARQ processes, which will not be limited herein.

Those of ordinary skill in the art may understand that the preconfigured resource-based SDT may be completed by using any one of the foregoing two operations. The foregoing two operations may be divided into two different embodiments.

In conclusion, according to the method provided in the embodiment, a method of retransmitting the first message on the CG resource and a method of stopping transmitting the first message on the CG resource are added, which fully considers the balance between ensuring successful transmission and power consumption during the use of the CG resource, and further enriches the mechanism for transmitting the first message during the preconfigured resource-based SDT.

As for continuously transmitting the first message on a DG resource scheduled for retransmission by a network device, FIG. 13 is a flowchart of a method for preconfigured resource-based SDT provided in an embodiment of the disclosure. The method may be implemented by the terminal device illustrated in FIG. 4, and the method includes the following.

At 310, a terminal device transmits a first message during operation of a first timer after selecting a CG-SDT.

This operation may refer to operation 310 in the embodiment illustrated in FIG. 5, which will not be elaborated again herein.

At 328, the terminal device stops transmitting the first message on a CG resource and retransmits the first message on a DG resource scheduled by a dynamic scheduling, during the operation of the first timer and before receiving a correct reception feedback from a network device, and when the dynamic scheduling is received from the network device.

The DG resource is a dynamic resource scheduled by the network device. Exemplarily, the network device schedules the DG resource for transmitting the first message when the first message is received but not successfully decoded. The DG resource is usually different from the CG resource, but possibilities exist that the DG resource is the same as the CG resource. Exemplarily, HARQ processes on the same resource have the same ID, and HARQ processes on different resources have different IDs.

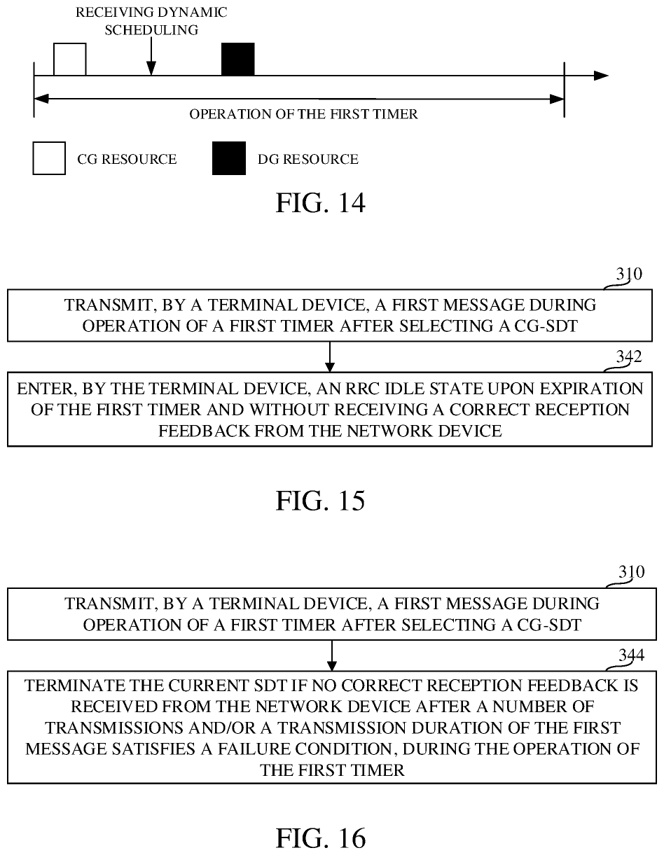

After receiving the dynamic scheduling from the network device, the terminal device stops transmitting the first message on the CG resource and retransmits the first message on the DG resource scheduled by the dynamic scheduling. FIG. 14 is a diagram of a time-frequency resource of the transmission process of CG-SDT provided in an embodiment of the disclosure. One CG resource and one DG resource are illustrated in the diagram of the time-frequency resource. The terminal device stops transmitting the first message on the CG resource and retransmits the first message on the DG resource when receiving the dynamic scheduling from the network device.

In conclusion, according to the method provided in the embodiment, the first message is transmitted during the operation of the first timer, thereby improving the mechanism for transmitting the first message during the preconfigured resource-based SDT. In addition, a method of transmitting the first message on the DG resource scheduled for retransmission by the network device without receiving the correct reception feedback from the network device is provided, thereby further ensuring that the first message can be successfully transmitted in an initial transmission phase.

In the present disclosure, there are three implementations after the first message is transmitted during the operation of the first timer.

In implementation 1, the terminal device enters an RRC idle state. FIG. 15 is a flowchart of a method for preconfigured resource-based SDT based on implementation 1.

In implementation 2, the terminal device terminates the current SDT. FIG. 16 is a flowchart of a method for preconfigured resource-based SDT based on implementation 2.

In implementation 3, the terminal device falls back to an RA-SDT or an RACH procedure. FIG. 18 is a flowchart of a method for preconfigured resource-based SDT based on implementation 3.

The three implementations are described in detailed below.

### Implementation 1

At 342, the terminal device enters an RRC idle state upon expiration of the first timer and without receiving a correct reception feedback from the network device.

Exemplarily, the terminal device entering the RRC idle state means that the SDT is ended, and the correct reception feedback indicates that the first message is received and successfully decoded.

### Implementation 2

At 344, the terminal device terminates the current SDT if no correct reception feedback is received from the network device after a number of transmissions and/or a transmission duration of the first message satisfies a failure condition, during the operation of the first timer.

The terminal device terminating the current SDT means that the SDT is not successfully completed.

Exemplarily, the failure condition includes but is not limited to at least one of: the number of transmissions of the first message reaching a threshold, and a third timer expiring.

The third timer is used to time an attempt to transmit the first message. Exemplarily, the terminal device starts the third timer after selecting the CG-SDT. A duration of the third timer is configured by the network device. Optionally, the third timer is a timer maintained at a lower layer. For example, the third timer is a timer maintained at a MAC layer. Exemplarily, the third timer is used to improve the speed of detecting whether the first message is successfully transmitted.

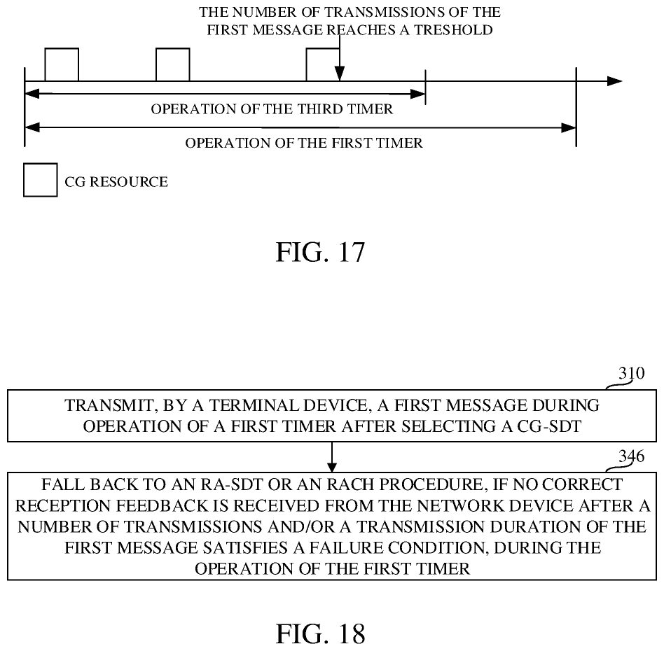

FIG. 17 is a diagram of a time-frequency resource of the transmission process of CG-SDT provided in an embodiment of the disclosure. Three CG resources are illustrated in the diagram of the time-frequency resource. The terminal device stops transmitting the first message when the third timer expires and/or the number of transmissions of the first message reaches the threshold.

Optionally, in implementation 2, a first configuration message is further received, where the first configuration message is used to configure the threshold or the duration of the third timer. The duration of the third timer indicates a failure condition of the transmission duration of the first message, and the threshold of the number of transmissions of the first message indicates a failure condition of the number of transmissions of the first message.

### Implementation 3

At 346, the terminal device falls back to an RA-SDT or an RACH procedure, if no correct reception feedback is received from the network device after a number of transmissions and/or a transmission duration of the first message satisfies a failure condition, during the operation of the first timer.

For the description of the failure condition in this operation, reference may be made to the foregoing operation 344, which will not be repeated herein.

Exemplarily, the terminal device falls back to the RA-SDT when an execution condition of the RA-SDT is satisfied. The terminal device falls back to the RACH procedure when the execution condition of the RA-SDT is not satisfied.

The execution condition of the RA-SDT includes but is not limited to: an RA-SDT resource existing and/or an RSRP threshold for executing the RA-SDT being satisfied.

Optionally, in implementation 3, a first configuration message is further received, where the first configuration message is used to configure the threshold or a duration of the third timer. The duration of the third timer indicates a failure condition of the transmission duration of the first message, and the threshold of the number of transmissions of the first message indicates a failure condition of the number of transmissions of the first message.

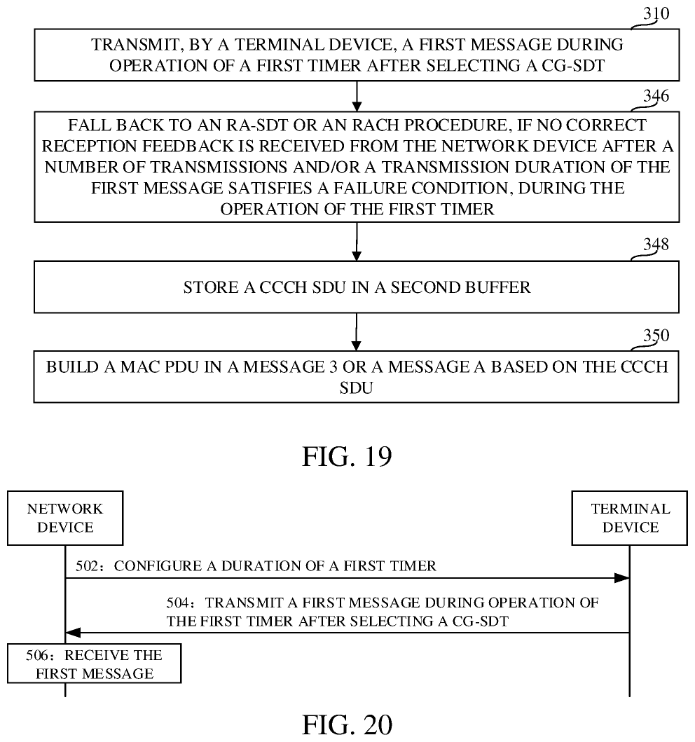

Optionally, referring to FIG. 19, the following operations may be also included in the embodiment.

At 348, a common control channel (CCCH) service data unit (SDU) is stored in a second buffer.

Exemplarily, the CCCH SDU is a CCCH SDU of an RRC resume request message.

The terminal device stores the CCCH SDU in the second buffer when receiving the RRC resume request message from a higher layer. Exemplarily, when obtaining the RRC resume request message, a non-access stratum (NAS) of the terminal device stores the CCCH SDU of the RRC resume request message in the second buffer before the 1st transmission of the first message.

At 350, a MAC PDU in a message 3 (Msg 3) or a message A (Msg A) is built based on the CCCH SDU.

The CCCH SDU is obtained from the second buffer during the building of the MAC PDU in the Msg 3 or the Msg A.

Exemplarily, in a situation of falling back to a four-step RA-SDT, the MAC PDU in the Msg 3 is built based on the CCCH SDU. In a situation of falling back to a two-step RA-SDT, the MAC PDU in the Msg A is built based on the CCCH SDU.

FIG. 20 is a flowchart of a method for preconfigured resource-based SDT provided in an embodiment of the disclosure. A terminal device in this method may be implemented as the terminal device illustrated in FIG. 4, and a network device in this method may be implemented as the network device illustrated in FIG. 4. The method includes the following.

At 502, a network device configures a duration of a first timer for a terminal device.

Exemplarily, the terminal device starts the first timer after selecting a CG-SDT. A duration of the first timer is configured by the network device. Exemplarily, the first timer is used to control the SDT. Optionally, the first timer is a timer maintained at an RRC layer.

The duration of the first timer is configured, so that the terminal device transmits a first message during operation of the first timer.

At 504, the terminal device transmits a first message during operation of the first timer after selecting a CG-SDT.

This operation may refer to operation 310 in the embodiment illustrated in FIG. 5, which will not be elaborated again herein.

At 506, the network device receives the first message.

The first message includes a 1st uplink message sent in the SDT, and the 1st uplink message at least includes an RRC message.

In conclusion, according to the method provided in the embodiment, the first timer is added and the first message is transmitted during the operation of the first timer, thereby improving the mechanism for transmitting the first message during the preconfigured resource-based SDT, ensuring that the first message can be transmitted in an initial transmission phase, and providing a solution for transmitting the first message.

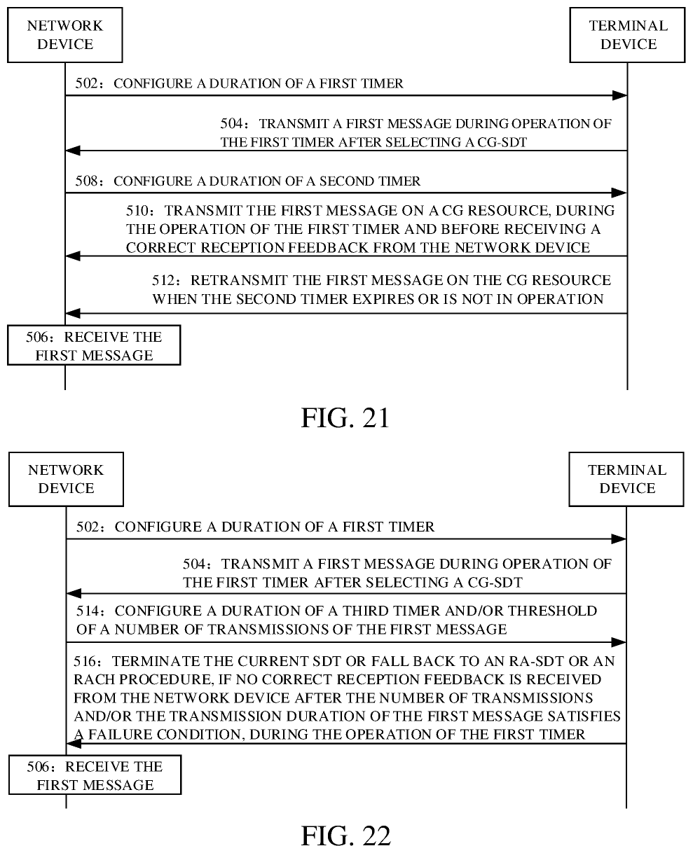

FIG. 21 is a flowchart of a method for preconfigured resource-based SDT provided in an embodiment of the disclosure. A terminal device in this method may be implemented as the terminal device illustrated in FIG. 4, and a network device in this method may be implemented as the network device illustrated in FIG. 4. The method includes the following.

At 502, a network device configures a duration of a first timer for a terminal device.

This operation may refer to operation 502 in the embodiment illustrated in FIG. 20, which will not be elaborated again herein.

At 504, the terminal device transmits a first message during operation of the first timer after selecting a CG-SDT.

This operation may refer to operation 310 in the embodiment illustrated in FIG. 5, which will not be elaborated again herein.

At 508, the network device configures a duration of a second timer for the terminal device.

Exemplarily, the terminal device starts the second timer when completing the transmission of the first message on a CG resource. The duration of the second timer is configured by the network device. Exemplarily, the second timer is a CGRT.

The duration of the second timer is configured, so that the terminal device retransmits the first message on a CG resource when the second timer expires or is not in operation.

It is to be noted that, operation 508 may be implemented before, after, or simultaneously with operation 504. An execution time sequence of the foregoing two operations is not limited in embodiments of the disclosure. The duration of the first timer and the duration of the second timer may be configured simultaneously or separately. The first timer and the second timer may be configured via one signaling, or may be configured separately via multiple different signalings. A configuration method of the duration of the first timer and the duration of the second timer is not limited in embodiments of the disclosure.

At 510, the terminal device transmits the first message on a CG resource, during the operation of the first timer and before receiving a correct reception feedback from the network device.

This operation may refer to operation 320a in the embodiment illustrated in FIG. 11, which will not be elaborated again herein.

At 512, the terminal device retransmits the first message on the CG resource when the second timer expires or is not in operation.

This operation may refer to operation 334 in the embodiment illustrated in FIG. 11, which will not be elaborated again herein.

At 506, the network device receives the first message.

This operation may refer to operation 506 in the embodiment illustrated in FIG. 20, which will not be elaborated again herein.

In conclusion, according to the method provided in the embodiment, a method of retransmitting the first message on the CG resource is added, which fully considers using the CG resource for retransmission to ensure successful transmission during the use of the CG resource, and further enriches the mechanism for transmitting the first message during the preconfigured resource-based SDT.

FIG. 22 is a flowchart of a method for preconfigured resource-based SDT provided in an embodiment of the disclosure. A terminal device in this method may be implemented as the terminal device illustrated in FIG. 4, and a network device in this method may be implemented as the network device illustrated in FIG. 4. The method includes the following.

At 502, a network device configures a duration of a first timer for a terminal device.

This operation may refer to operation 502 in the embodiment illustrated in FIG. 20, which will not be elaborated again herein.

At 504, the terminal device transmits a first message during operation of the first timer after selecting a CG-SDT.

This operation may refer to operation 310 in the embodiment illustrated in FIG. 5, which will not be elaborated again herein.

At 514, the network device configures a duration of a third timer and/or a threshold of a number of transmissions of the first message for the terminal device.

The third timer is used to time an attempt to transmit the first message. Exemplarily, the terminal device starts the third timer after selecting the CG-SDT. The duration of the third timer is configured by the network device. Optionally, the third timer is a timer maintained at a lower layer. For example, the third timer is a timer maintain at a MAC layer. Exemplarily, the third timer is used to improve the speed of detecting whether the first message is successfully transmitted.

The duration of the third timer indicates a failure condition of a transmission duration of the first message, and the threshold of the number of transmissions of the first message indicates a failure condition of the number of transmissions of the first message.

It is to be noted that, operation 514 may be implemented before, after, or simultaneously with operation 504. An execution time sequence of the foregoing two operations is not limited in embodiments of the disclosure.

The duration of the first timer, the duration of the third timer, and the threshold of the number of transmissions of the first message may be configured simultaneously or separately. The duration of the first timer, the duration of the third timer, and the threshold of the number of transmissions of the first message may be configured via one signaling, or may be configured separately via multiple different signalings. A configuration method of the duration of the first timer, the duration of the third timer, and the threshold of the number of transmissions of the first message is not limited in embodiments of the disclosure.

At 516, the terminal device terminates the current SDT or falls back to an RA-SDT or an RACH procedure, if no correct reception feedback is received from the network device after the number of transmissions and/or the transmission duration of the first message satisfies a failure condition, during the operation of the first timer.

This operation may refer to operation 344 in the embodiment illustrated in FIG. 16, or operation 346 in the embodiment illustrated in FIG. 18, which will not be elaborated again herein.

At 506, the network device receives the first message.

This operation may refer to operation 506 in the embodiment illustrated in FIG. 20, which will not be elaborated again herein.

In conclusion, according to the method provided in the embodiment, the first timer is added and the first message is transmitted during the operation of the first timer, thereby improving the mechanism for transmitting the first message during the preconfigured resource-based SDT, ensuring that the first message can be transmitted in an initial transmission phase, and providing a solution for transmitting the first message.

Those of ordinary skills in the art may understand that embodiments above may be independent embodiments, or may be combined with another embodiment as a new embodiment, which is not specifically limited herein.

Device embodiments of the disclosure are described below, which may be used to perform the method embodiments of the disclosure. For details that are not disclosed in the device embodiments of this disclosure, refer to the method embodiments of this disclosure.

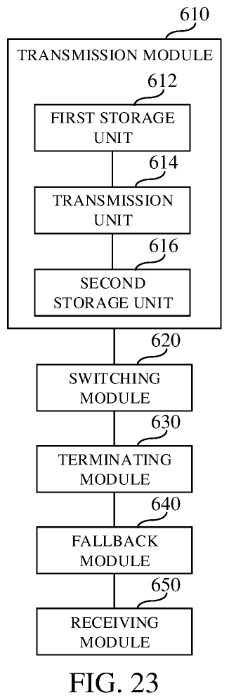

FIG. 23 is a block diagram of a device for preconfigured resource-based SDT provided in an embodiment of the disclosure. The device includes a transmission module 610.

The transmission module 610 is configured to transmit a first message during operation of a first timer after selecting a CG-SDT.

The first message includes a 1st uplink message sent during the SDT, and the 1st uplink message at least includes an RRC message.

In an optional design of the embodiment, the transmission module 610 is further configured to transmit the first message on a CG resource or a DG resource scheduled for retransmission by a network device, during the operation of the first timer and before receiving a correct reception feedback from the network device.

In an optional design of the embodiment, the transmission module 610 is further configured to skip transmitting a second message, during the operation of the first timer and without receiving the correct reception feedback from the network device, where the second message is a message to be transmitted in a subsequent transmission phase of the SDT.

In an optional design of the embodiment, the transmission module 610 is further configured to transmit the first message on a CG resource with a HARQ process the same as the 1st transmission of the first message, during the operation of the first timer and before receiving the correct reception feedback from the network device.

In an optional design of the embodiment, the transmission module 610 includes a first storage unit 612 and a transmission unit 614.

The first storage unit 612 is configured to generate a MAC PDU of the first message and store the MAC PDU in a first buffer, during the operation of the first timer and before receiving the correct reception feedback from the network device.

The transmission unit 614 is configured to transmit, based on the first buffer, the MAC PDU of the first message on a CG resource with a HARQ process the same as or different from the 1st transmission of the first message.

In an optional design of the embodiment, when transmitting the MAC PDU of the first message on a CG resource with a HARQ process different from the 1st transmission of the first message, the device further includes a second storage unit 616.

The second storage unit 616 is configured to store the MAC PDU stored in the first buffer into a buffer corresponding to any HARQ process, when the device newly transmits the first message on a CG resource of the any HARQ process.

In an optional design of the embodiment, the MAC PDU is generated during the 1st transmission of the first message after the device selects the CG-SDT.

In an optional design of the embodiment, the transmission module 610 is further configured to stop transmitting the first message on the CG resource when the correct reception feedback is received from the network device, or retransmit the first message on the CG resource when a second timer expires or is not in operation.

In an optional design of the embodiment, the second timer is a CGRT.

In an optional design of the embodiment, the transmission module 610 is further configured to stop transmitting the first message on the CG resource and retransmit the first message on a DG resource scheduled by a dynamic scheduling, during the operation of the first timer and before receiving the correct reception feedback from the network device, and when the dynamic scheduling is received from the network device, where the dynamic scheduling is for scheduling retransmission of the first message.

In an optional design of the embodiment, the device further includes a switching module 620. The switching module 620 is configured to cause the device to enter an RRC idle state upon expiration of the first timer and without receiving a correct reception feedback from the network device.

In an optional design of the embodiment, the device further includes a terminating module 630. The terminating module 630 is configured to terminate the current SDT if no correct reception feedback is received from the network device after a number of transmissions and/or a transmission duration of the first message satisfies a failure condition, during the operation of the first timer.

In an optional design of the embodiment, the device further includes a fallback module 640. The fallback module 640 is configured to fall back to an RA-SDT or an RACH procedure, if no correct reception feedback is received from the network device after the number of transmissions and/or the transmission duration of the first message satisfies the failure condition, during the operation of the first timer.

In an optional design of the embodiment, the failure condition includes at least one of: the number of transmissions of the first message reaching a threshold, and a third timer expiring, where the third timer is used to time an attempt to transmit the first message.

In an optional design of the embodiment, the device further includes a receiving module 650. The receiving module 650 is configured to receive a first configuration message, where the first configuration message is used to configure the threshold or a duration of the third timer.

In an optional design of the embodiment, the fallback module is configured to: fall back to the RA-SDT when an execution condition of the RA-SDT is satisfied, and falling back to the RACH procedure when the execution condition of the RA-SDT is not satisfied.

In an optional design of the embodiment, the execution condition of the RA-SDT includes: an RA-SDT resource existing, and/or an RSRP threshold for executing the RA-SDT being satisfied.

In an optional design of the embodiment, the fallback module 640 is further configured to store a CCCH SDU in a second buffer, where the CCCH SDU is a CCCH SDU of an RRC resume request message, and configured to build a MAC PDU in a Msg 3 or a Msg A based on the CCCH SDU.

In an optional design of the embodiment, the RRC message is an RRC resume request message.

In an optional design of the embodiment, the 1st uplink message further includes terminal data and/or a MAC CE.

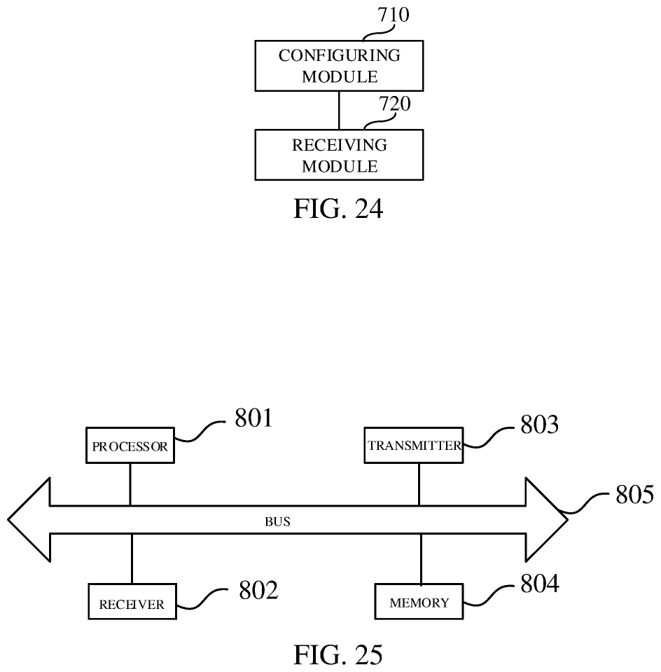

FIG. 24 is a block diagram of a device for preconfigured resource-based SDT provided in an embodiment of the disclosure. The device includes a configuring module 710 and a receiving module 720.

The configuring module 710 is configured to configure a duration of a first timer for a terminal device, so that the terminal device transmits a first message during operation of the first timer.

The receiving module 720 is configured to receive the first message, where the first message includes a 1st uplink message sent during SDT, and the 1st uplink message at least includes an RRC message.

In an optional design of the embodiment, the configuring module 710 is further configured to configure a duration of a second timer for the terminal device, so that the terminal device retransmits the first message on a CG resource when the second timer expires or is not in operation.

In an optional design of the embodiment, the configuring module 710 is further configured to configure a duration of a third timer for the terminal device, where the duration of the third timer indicates a failure condition of a transmission duration of the first message, and/or configure a threshold of a number of transmissions of the first message, where the threshold of the number of transmissions of the first message indicates a failure condition of the number of transmissions of the first message.

It should be noted that, when the device provided in the foregoing embodiments implements its functions, only the division into the above functional modules is taken an example for illustration. In practice, the above functions can be allocated to different functional modules according to actual needs, that is, the structure of the device is divided into different functional modules to complete all or some of the functions described above.

Regarding the device in the foregoing embodiments, the manner in which each module performs operations has been described in detail in the related method embodiments, which will not be elaborated again herein.

FIG. 25 is a schematic structural diagram of a communication apparatus provided in an embodiment of the disclosure. The communication apparatus may include a processor 801, a receiver 802, a transmitter 803, a memory 804, and a bus 805.

The processor 801 includes one or more processing cores. The processor 801 executes various function applications and information processing by running a software program and a module.

The receiver 802 and the transmitter 803 may be implemented as a transceiver, and the transceiver may be a communication chip.

The memory 804 is connected to the processor 801 through the bus 805. Exemplarily, the processor may be implemented as a first integrated circuit (IC) chip, and the processor 801 and the memory 804 may be implemented together as a second IC chip. The first IC chip or the second IC chip may be an application specific IC (ASIC) chip.

The memory 804 may store at least one computer program. The processor 801 is configured to execute the at least one computer program to implement operations in the foregoing method embodiments.

In addition, the memory 804 may be implemented by any type of volatile or nonvolatile storage device or combination thereof. The volatile or non-volatile storage device includes, but is not limited to, a random access memory (RAM), a read-only memory (ROM), an erasable programmable read-only memory (EPROM), an electrically erasable programmable read-only memory (EEPROM), a flash memory or other solid state storage devices, a compact disc ROM (CD-ROM), a digital video disc (DVD) or other optical storage, magnetic cassettes, magnetic tape, magnetic disk storage or other magnetic storage devices.

An embodiment of the present disclosure further provides a computer readable storage medium that stores a computer program. The computer program may be executed by a processor of a multi-link device to implement the foregoing method for preconfigured resource-based SDT.

Optionally, the computer readable storage medium may include a ROM, a RAM, a solid state drive (SSD), a disc, etc. The RAM may include a resistance RAM (ReRAM) and a dynamic RAM (DRAM).

An embodiment of the present disclosure further provides a chip including a programmable logic circuit and/or a program instruction. The chip, when running on a multi-link device, is configured to implement the foregoing method of preconfigured resource-based SDT.

An embodiment of the present disclosure further provides a computer program product or a computer program. The computer program product or the computer program includes a computer instruction, which is stored in a computer readable storage medium. A processor of a multi-link device reads the computer instruction from the computer readable storage medium and executes the computer instruction to implement the foregoing method for preconfigured resource-based SDT.

It is to be understood that the term “indicate” as used in the embodiments of the present disclosure may be a direct indication, an indirect indication, or an association. For example, if A indicates B, it may mean that A directly indicates B, e.g., B can be obtained from A. Alternatively, it may mean that A indicates B indirectly, e.g., A indicates C and B can be obtained from C. Alternatively, it may mean that there is an association between A and B.

In the description of the embodiments of the present disclosure, the term “corresponding” maymean that there is a direct or indirect correspondence between the two, or may mean that there is an association between the two, or that they are in a relation of indicating and indicated, configuring or configured, or the like.

In this specification, “multiple” refers to at least two. The term “and/or” describes an association relationship for describing associated objects and represents that three relationships may exist. For example, A and/or B may represent the following three cases: Only A exists, both A and B exist, and only B exists. The character “/” generally indicates an “or” relationship between the associated objects.

In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence illustrated in the figure. This is not limited in the embodiments of the disclosure.

Those of ordinary skill in the art should be aware that in the foregoing one or more examples, functions described in the embodiments of this specification may be implemented by hardware, software, firmware, or any combination thereof. When a software is used to implement the embodiments, the foregoing functions may be stored in a computer readable medium or transmitted as one or more instructions or codes in the computer readable medium. The computer readable medium includes a computer storage medium and a communication medium, where the communication medium includes any medium that facilitates transfer of a computer program from one place to another, and the storage medium may be any available medium that can be accessed by a general-purpose computer or a special-purpose computer.

The above are merely optional embodiments of the disclosure and are not intended to limit the disclosure. Any modification, equivalent arrangements, and improvement made within the spirit and principles of the disclosure shall be included in the scope of protection of the disclosure.

What is claimed is:

1. A method for preconfigured resource-based small data transmission (SDT), comprising:
transmitting, by a terminal device, a first message during operation of a first timer after selecting a configured grant (CG)-SDT, wherein
the first message comprises a 1st uplink message sent during the SDT, and the 1st uplink message at least comprises a radio resource control (RRC) message.

2. The method of claim 1, further comprising:
transmitting the first message on a CG resource or a dynamic grant (DG) resource scheduled for retransmission by a network device, during the operation of the first timer and before receiving a correct reception feedback from the network device.

3. The method of claim 2, wherein transmitting the first message on the CG resource, during the operation of the first timer and before receiving the correct reception feedback from the network device comprises:
transmitting the first message on a CG resource with a hybrid automatic repeat request (HARQ) process the same as a 1st transmission of the first message, during the operation of the first timer and before receiving the correct reception feedback from the network device.

4. The method of claim 2, further comprising:
stopping transmitting the first message on the CG resource when the correct reception feedback is received from the network device; or
retransmitting the first message on the CG resource when a second timer expires or is not in operation.

5. The method of claim 1, further comprising:
entering, by the terminal device, an RRC idle state upon expiration of the first timer and without receiving a correct reception feedback from a network device.

6. The method of claim 1, further comprising:
terminating a current SDT if no correct reception feedback is received from a network device after a number of transmissions and/or a transmission duration of the first message satisfies a failure condition, during the operation of the first timer.

7. The method of claim 1, further comprising:
falling back to a random access (RA)-SDT or a random access channel (RACH) procedure, if no correct reception feedback is received from a network device after a number of transmissions and/or a transmission duration of the first message satisfies a failure condition, during the operation of the first timer.

8. The method of claim 6, wherein the failure condition comprises at least one of:
the number of transmissions of the first message reaching a threshold; and
a third timer expiring, wherein the third timer is used to time an attempt to transmit the first message.

9. The method of claim 7, wherein falling back to the RA-SDT or the RACH procedure comprises:
falling back to the RA-SDT when an execution condition of the RA-SDT is satisfied; and
falling back to the RACH procedure when the execution condition of the RA-SDT is not satisfied.

10. A method for preconfigured resource-based small data transmission (SDT), comprising:
configuring, by a network device, a duration of a first timer for a terminal device, so that the terminal device transmits a first message during operation of the first timer; and
receiving, by the network device, the first message, wherein the first message comprises a 1st uplink message sent during SDT, and the 1st uplink message at least comprises a radio resource control (RRC) message.

11. The method of claim 10, further comprising:
configuring, by the network device, a duration of a second timer for the terminal device, so that the terminal device retransmits the first message on a CG resource when the second timer expires or is not in operation.

12. The method of claim 10, further comprising:
configuring, by the network device, a duration of a third timer for the terminal device, wherein the duration of the third timer indicates a failure condition of a transmission duration of the first message; and/or
configuring, by the network device, a threshold of a number of transmissions of the first message, wherein the threshold of the number of transmissions of the first message indicates a failure condition of the number of transmissions of the first message.

13. A terminal device comprising:
a transceiver;
a memory configured to store computer programs; and
a processor configured to execute the computer programs stored in the memory to cause the transceiver to:
transmit a first message during operation of a first timer after selecting a configured grant (CG)-SDT, wherein
the first message comprises a 1st uplink message sent during the SDT, and the 1st uplink message at least comprises a radio resource control (RRC) message.

14. The terminal device of claim 13, wherein the processor is further configured to cause the transceiver to:
transmit the first message on a CG resource or a dynamic grant (DG) resource scheduled for retransmission by a network device, during the operation of the first timer and before receiving a correct reception feedback from the network device.

15. The terminal device of claim 14, wherein the processor is further configured to cause the transceiver to:
transmit the first message on a CG resource with a hybrid automatic repeat request (HARQ) process the same as a 1st transmission of the first message, during the operation of the first timer and before receiving the correct reception feedback from the network device.

16. The terminal device of claim 14, wherein the processor is further configured to cause the transceiver to:
stop transmitting the first message on the CG resource when the correct reception feedback is received from the network device; or
retransmit the first message on the CG resource when a second timer expires or is not in operation.

17. The terminal device of claim 13, wherein the processor is further configured to:
cause the terminal device to enter an RRC idle state upon expiration of the first timer and without receiving a correct reception feedback from a network device.

18. The terminal device of claim 13, wherein the processor is further configured to:
terminate a current SDT if no correct reception feedback is received from a network device after a number of transmissions and/or a transmission duration of the first message satisfies a failure condition, during the operation of the first timer.

19. The terminal device of claim 13, wherein the processor is further configured to:
fall back to a random access (RA)-SDT or a random access channel (RACH) procedure, if no correct reception feedback is received from a network device after a number of transmissions and/or a transmission duration of the first message satisfies a failure condition, during the operation of the first timer.

20. The terminal device of claim 18, wherein the failure condition comprises at least one of:
the number of transmissions of the first message reaching a threshold; and
a third timer expiring, wherein the third timer is used to time an attempt to transmit the first message.
